(19) United States
(12) Patent Application Publication
(10) Pub. No.: US 2017/0100961 A1
(43) Pub. Date: Apr. 13, 2017

(54) ACTIVE CONTAINER

(71) Applicant: Bluesmart Inc., New York, NY (US)

(72) Inventors: Martin DIZ, Buffalo, NY (US); Brian CHEN, New York, NY (US); Alejo VERLINI, Buenos Aires (AR); Alejandro SARRA, Buenos Aires (AR); Diego Martin SAEZ-GIL, Brooklyn, NY (US); Tomas Mario PIERUCCI, Buenos Aires (AR)

(21) Appl. No.: 15/389,044

(22) Filed: Dec. 22, 2016

Related U.S. Application Data
(62) Division of application No. 14/722,980, filed on May 27, 2015.
(60) Provisional application No. 62/003,274, filed on May 27, 2014.

(51) Int. Cl. B60B 27/00; B60B 11/02; B62D 5/04; B60B 5/02; B60K 7/00; B60R 16/03

(52) U.S. Cl. CPC B60B 27/0015; B60K 7/0007; B60R 16/0307; B62D 5/0418; B60B 5/02; B60B 27/0005; B60B 11/02; B60B 2360/32; B60B 2380/12; B60B 2200/45; B60B 33/0042

(57) ABSTRACT

A multi-functional active container (e.g., luggage or suitcase) with a plurality of sensors and actuators is described. The container may include a body defining an enclosure and having at least one opening. The container may include a processor, a wireless receiver, and an electronically controllable lock. The processor can selectively lock or unlock the electronically controllable lock based on signals received via a wireless receiver (e.g., via Wi-Fi or BLUETOOTH connections). In some examples, a distance between the active container and a remote device (e.g., a smart phone) can be determined (e.g., based on relative GPS signals or connection strength) and if the distance exceeds a threshold, the electronically controllable lock can be activated to secure the container. Further, the container may include a rechargeable power source for powering external devices and an integrated weight sensor for detecting the weight of the container.

### CROSS-REFERENCE TO RELATED APPLICATION

This application claims the benefit of U.S. Provisional Patent Application Ser. No. 62/003,274, filed May 27, 2014, the disclosure of which is hereby incorporated by reference in its entirety for all purposes.

### FIELD

This relates to the field of containers, and in one example, to multi-functional luggage for transporting items on airplanes, trains, cars, and the like.

### BACKGROUND

People have always traveled, and whether it is for clothes, tools, or electronics, travelers have always used containers to move their belongings from one place to another, allowing them to carry one item that fits many items. The evolution of transportation (e.g., via trains, cars, airplanes, etc.) has enabled travelers to move faster and more frequently. The increase in travel has increased various issues arising with regard to the containers themselves, such as loss, theft, break-in, assuring weight compliance/monitoring, and so on.

Modern luggage for carrying personal items generally lacks the ability to satisfy the wants of the modern traveler, whether it is for increased security of the container and its contents, or to serve the ever increasing demands of the electronic devices (e.g., phone, laptop, tablet, etc.) a typical traveler possess. Accordingly, more active containers (e.g., luggage) capable of providing enhanced security and electronic support are desired.

### BRIEF SUMMARY

The present invention is directed to a multi-functional active container (e.g., a luggage or suitcase item) with a plurality of sensors and actuators, which may include an electronically controllable lock and a rechargeable power source for charging external devices.

In one aspect and one example, the multifunctional active container includes a body defining an enclosure and having at least one opening. The body may include a processor, a wireless receiver, and an electronically controllable lock. The processor can selectively lock or unlock the electrically controllable lock, e.g., based on signals received via a wireless receiver (e.g., via Wi-Fi or BLUETOOTH connections). In some examples, a distance between the active container and a remote device (e.g., a user's smart phone) can be determined (e.g., based on GPS signals or connection strength) and if the distance exceeds a predetermined threshold, the electrically controllable lock can be activated to secure the active container.

Further, in some examples, the active container may include a weight sensor integrated with a handle coupled to the body of the active container. The processor and a wireless transceiver may operate to detect a signal from the weight sensor when a user lifts the luggage by the handle and transmit this information to a remote device.

In another aspect and example, a user interface, including an interactive center, for viewing the status and/or controlling aspects of the active container is provided. The user interface can be used to control the active container, e.g., to lock or unlock the active container, activate a location light associated therewith, and the like. The user interface can further display the status of the lock, the status of a battery included with the active container, a geographical map showing the location of the active container, the weight of the container, and the like.

Additionally, systems, electronic devices, graphical user interfaces, and non-transitory computer readable storage medium (the storage medium including programs and instructions for carrying out one or more processes described) for monitoring, controlling, and using active containers are described.

### FIGURES

The present application can be best understood by reference to the following description taken in conjunction with the accompanying drawing figures, in which like parts may be referred to by like numerals.

FIGS. 1A and 1B illustrate an exemplary active container according to one example.

FIGS. 2A and 2B illustrate an exploded and perspective view of an exemplary handle having an integrated weight sensor of an exemplary active container.

FIGS. 3A and 3B illustrate an exemplary remote locking apparatus for use with an exemplary active container.

FIG. 3C illustrates an exploded view of an exemplary remote locking mechanism in greater detail.

FIGS. 4A and 4B illustrate an exemplary wheel for use with an active container.

FIG. 5 illustrates an exemplary motor/generator that may be included with one or more wheels of an active container.

FIG. 6 illustrates an exemplary architecture and environment between an active container, a remote device, and external services.

FIGS. 7-9 illustrate exemplary processes for the active container and/or an information center associated with an active container.

FIGS. 10-15B illustrate exemplary screen shots of a user interface for interacting with the active container according to some examples.

FIG. 16 illustrates an exemplary computing system for performing processes described herein, and may be included with the active container, a remote device, or a combination thereof.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

In one embodiment described herein, an Active Container (hereinafter, “AC”) is provided. The AC may be used to transport personal items on a trip and reacts with and to external stimuli rather than merely recording and sending data. The AC is preferably in the form of luggage, such as a hard or soft suitcase or duffle, and its exterior may be formed of canvas, leather, or hard shell material such as hardened plastic or metal. The AC may or may not be on wheels and may have a pull handle. The capabilities of the AC are further extended with the use of an external or internal Information Center (hereinafter, “IC”), which stores, processes, displays, and gathers data from other internal and external devices to improve the user travel experience.

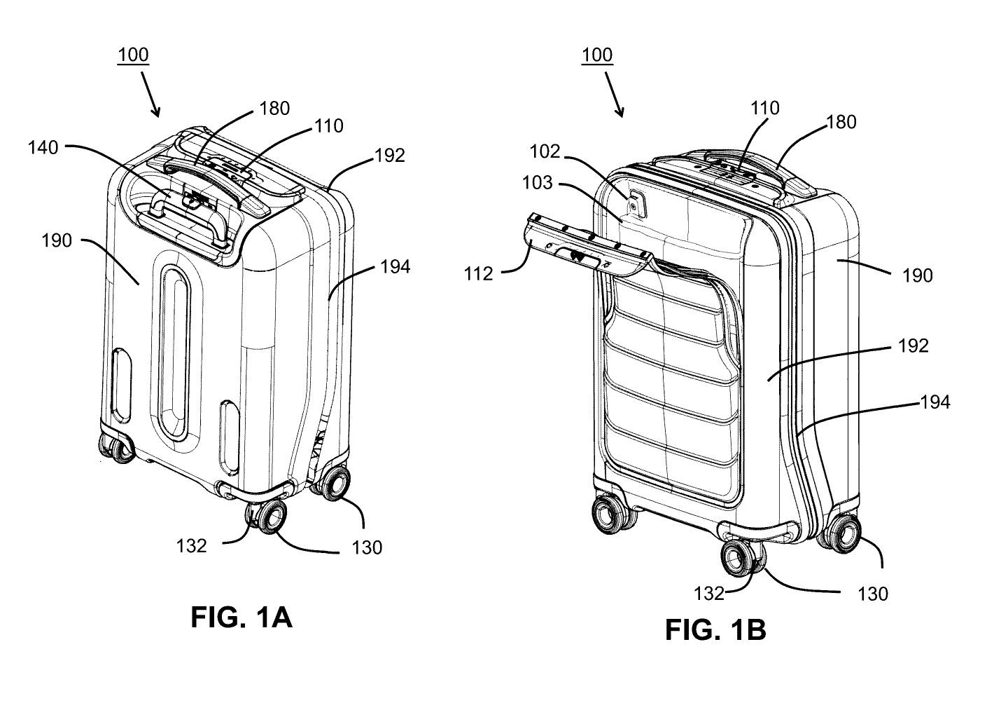

FIGS. 1A and 1B illustrate an exemplary AC 100 according to one example. Broadly, AC 100 includes a body 190 that defines a cavity for enclosing items and at least one opening, e.g., in the form of a flap 112 and/or door 192, that may be zippered or latched closed, e.g., along seem 194. AC 100 may further include an extendable pull handle 140, handle 180, and roller wheels 130. In this example, AC 100 is illustrated as a standard size carry-on luggage, having wheels 130 and an extendable handle 180 for ease of moving. However, in other examples, AC 100 may be of various sizes, including smaller and larger (e.g., substantially greater than conventional checked luggage or for shipment), and may include additional or fewer features than described herein.

AC 100 further includes a battery 103, which may be included within an enclosure or otherwise attached internally or externally to body 190, for powering internal devices (which may include, e.g., on board processors and sensors, a lock, lights, location sensors, weight sensors, and so on) as well as provide power to external devices via outlet 102 (e.g., providing for charging inputs, USB inputs, standard outlets, and so on). In some examples, a power outlet 103, e.g., a USB, fire wire, or other power and/or data outlet, may be included in an interior portion of AC 100 and accessible only when flap 112 is open. In other examples, an outlet 103 may be included and accessible from an exterior of AC 100, e.g., on the top portion near a plate or face supporting locking mechanism 110.

AC 100 further includes a lock 110 for securing the enclosure opening, which as described in greater detail below can be activated (locked or unlocked) remotely and/or based on pre-defined conditions being satisfied (e.g., exceeding a distance from a remote device). Lock 110 is shown in this example on the top portion, in a position to accept and secure flap 112 in position to secure the opening and door 192 to body 190. In other examples, lock 110 may be positioned on the side, bottom, or front of AC 100. AC 100 may further include multiple locking mechanisms, particularly if given the size, there are multiple openings or enclosures.

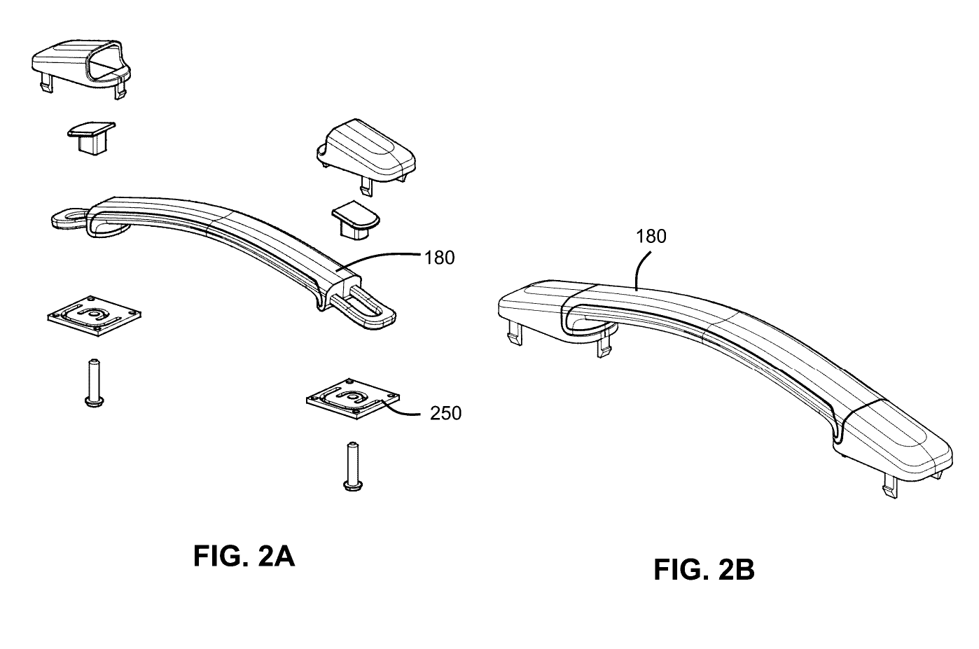

AC 100 further includes a weight sensor built into the handle 180 thereof. As seen more clearly in FIGS. 2A and 2B, a weight sensor may include an integrated load cell 250, built into handle 180, with one portion secured to the body of AC 100 and another portion secured to handle 180. Thus, when AC 100 is suspended by handle 180 (e.g., when a user lifts and suspends AC 100 by handle 180), load cell 250 of the weight sensor is deflected. The amount of deflection can be detected and used to determine the weight of the AC 100. Of course, other mechanisms may be used, e.g., conventional leaf springs, MEMS devices, strain gauges, capacitive or resistive pressure sensors, and so on. The detected weight, or signal associated with the weight, can be displayed on a screen associated with AC 100 and/or communicated to a remote device for display therewith, e.g., via the IC described in greater detail below. In other examples, a weight sensor could be integrated in a link between the wheels and the body of the AC, thereby providing a measure of the weight of the AC without a user having to suspend the AC from the handle (the weight of the wheels can be added to the detected weight).

Weight information can be used to determine if excess airline fees may be required (or if the luggage might be refused). Additionally, weight differences detected between departure and arrival may indicate that an item has been stolen from (or an item added to) AC 100 while not in the user's control.

Further, in this example, AC 100 includes roller wheels 130. Roller wheels 130 may include hollow wheels which may provide high durability while reducing the overall weight of AC 100. The hollow wheel design allows integrating large bearings into the wheels 130, where an internal hollow shaft is attached to a vertical rod 132 that connects to the body of AC 100, and a bearing coated with plastic, rubber, or other suitable material will be attached to the outer hollow shaft giving the wheel the ability to roll. In addition to reducing the weight, the hollow design facilitates the optional integration of a generator and/or motor since it provides a larger size with a smaller amount of material and weight.

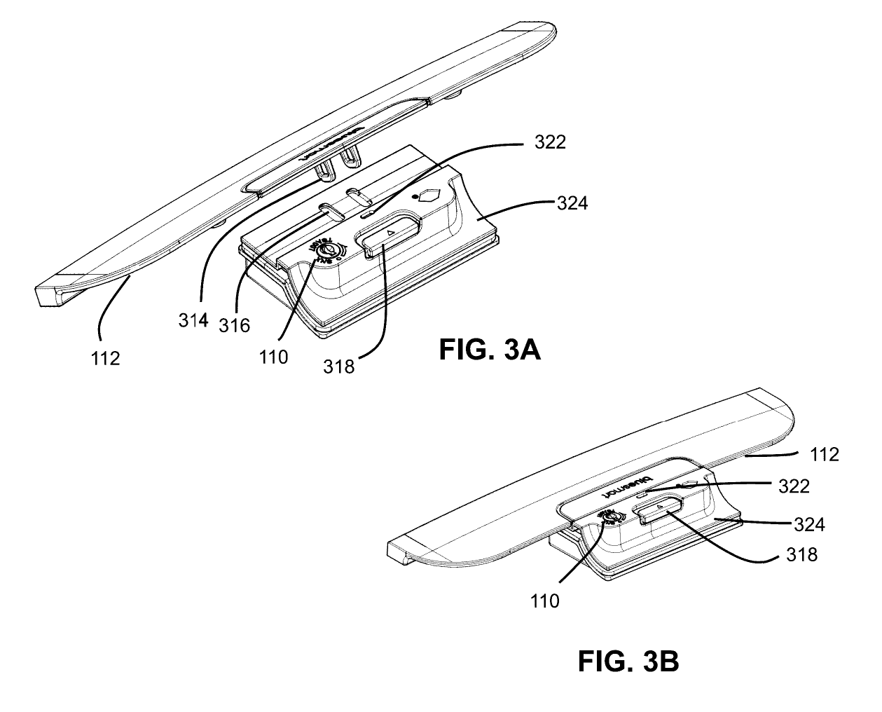

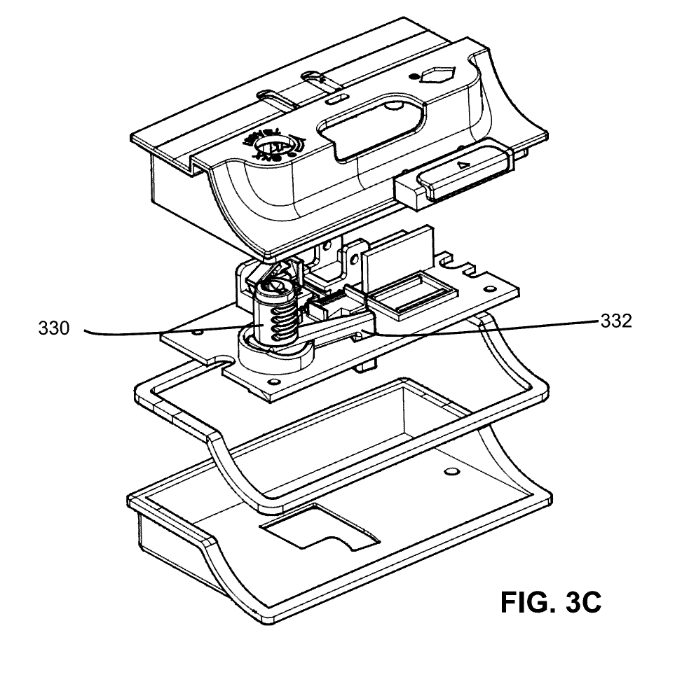

FIGS. 3A-3C illustrate a locking mechanism 110 of AC 100 in greater detail. In particular, locking mechanism 110 may include both a mechanical key locking mechanism as well as a solenoid or other electrically controlled locking mechanism for securing flap 112 to a portion of the AC body (e.g., fixed to body 190). In particular, and in this example, flap 112 includes two protrusions 314 for mating with interface 316 of the AC body. When protrusions 314 are inserted a catch may engage and hold protrusions 314 in a closed position, and which may be released by activation of button 318 when in an unlocked state. Locking mechanism 110 may be activated manually (e.g., via a combination or physical key) or electronically (via a lock/unlock signal) to secure protrusions 314 in place. As seen more clearly in FIG. 3C, as lock 330 rotates, e.g., via rotation of a key, a lever 332 may move to engage protrusions 314 in a locked position. Alternatively, a solenoid may be activated, e.g., extended, to engage protrusions 314 in the locked position. The AC body may further include an indicator 322, which may include an LED light or display for providing a visual indication to the user as to whether the AC is locked or unlocked.

In some examples, flap 112 may be attached to a first portion of the body and locking plate 324 attached to a second portion of the body, where the first portion and second portion operate to open relative to each other to access contents therein. In other examples, flap 312 and locking plate 324 may be positioned to render an opening mechanism (e.g., a zipper or latch) inaccessible when in the locked position.

The locking mechanism 110 can be controlled from the IC to lock and unlock. The locking mechanism 110 may further be integrated with a Transportation Security Administration (“TSA”) approved lock. In such an example, the locking mechanism 110 may include a three-way lock/unlock mechanism, whereby the lock's functioning is integrated with both mechanical and electrical elements. First, the device can be locked/unlocked electronically by use of the IC as described in greater detail below. Second, in the case of battery depletion (e.g., of the AC or the IC) the lock can be locked/unlocked with the use of a numerical combination (or alternatively a key). Third, the lock may be locked/unlocked with the use of a TSA master-key, e.g., available in airports by TSA agents. With the use of the IC data, it also is possible to lock and unlock the AC based on the user position, time of day, and geolocation. In case the AC is stolen, lost, or left behind, the AC will be able to react by locking itself. The correlation between the method used to open the AC, time, and geolocation will allow the user to identify who opened the AC and why.

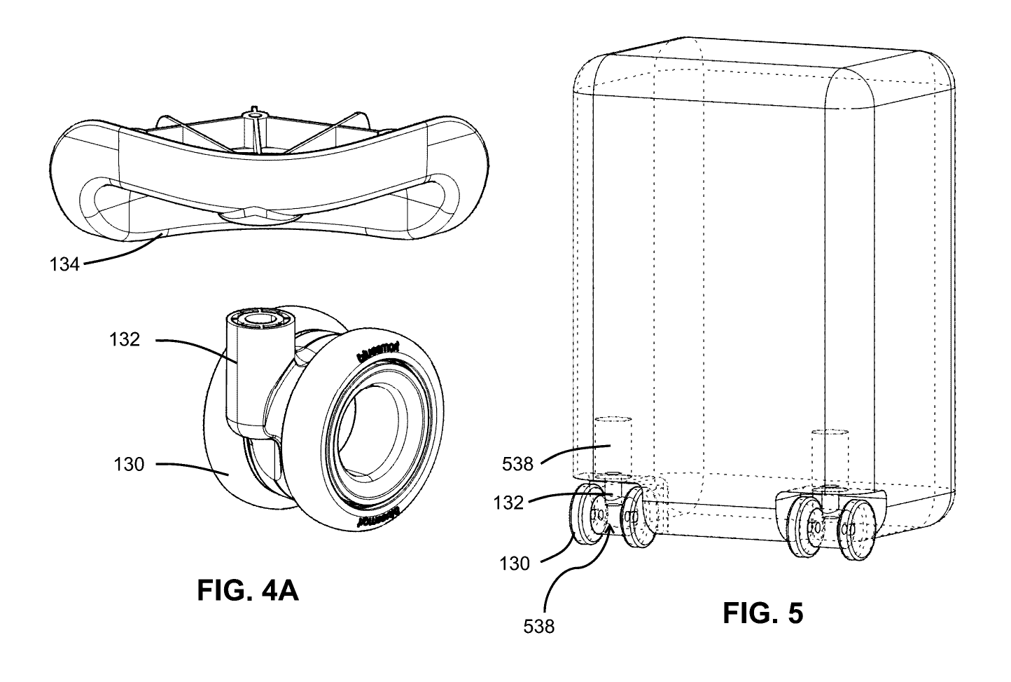

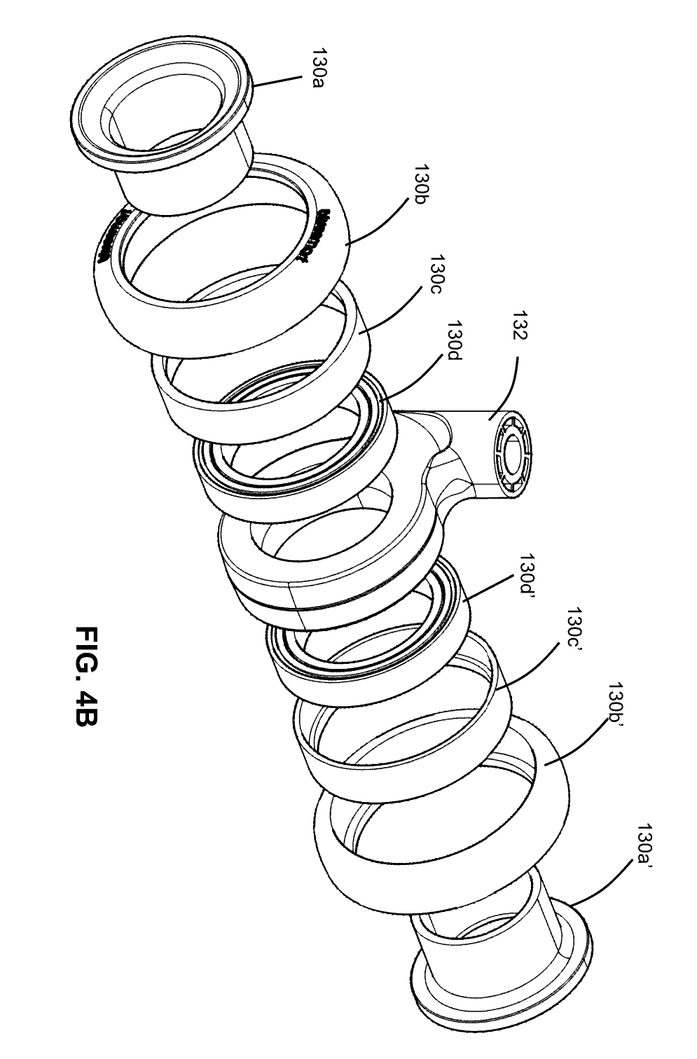

FIGS. 4A and 4B illustrate an exemplary wheel 130 in greater detail, and FIG. 5 illustrates an exemplary motor/generator that may be included with one or more wheels 130 of AC 100. In particular, FIG. 4A illustrate a mounting frame 134, which may be made of molded plastic or other suitable material, for attaching rod 132 and wheel 130 to AC 100. FIG. 4B illustrates an exploded view of an exemplary wheel 130, which includes inner hubs 130a, 130a′, outer wheels 130b, 130b′, and bearing members 130c, 130c′ and 130d, and 130d′. Inner hubs 130a, 130a′ are fixedly attached to rod 132 and generally support outer wheels 130b, 130b′ during rotation. Outer wheels 130b, 130b′ may rotate relative to inner hubs 130a, 130a′ and are supported by bearing members 130c, 130c′ and 130d, and 130d′, which may include plastic, rubber, or other low friction materials. In other examples, fewer or additional bearing members may be included, e.g., ball bearings, or the like.

FIG. 5 illustrates an exemplary motor/generator 537, which may be included with one or more wheels 130 of AC 100. For example, a motor/generator can be embedded on one the wheel mountings. The wheels are connected with a shaft to the motor such that the motor drives the shaft that drives the wheels. In some examples, one motor is included for each wheel to provide steering control of the AC, and further, a second motor 538 may be included, e.g., attached vertically to the wheel assembly, and provides a method for rotating/steering the wheels. Further, a second motor 538 may be attached vertically to provide an alternate method of steering. Motor rotate 538 may operate to rotate the wheels to reorient the active container.

In other embodiments, the motor components can be embedded into the wheel, e.g., either magnets or the coil, to reduce the overall weight. In this example the remaining parts of the motor can be embedded into the wheel mounting.

The motor(s) are further connected to the MCU to provide driving and/or steering control and the main battery for power.

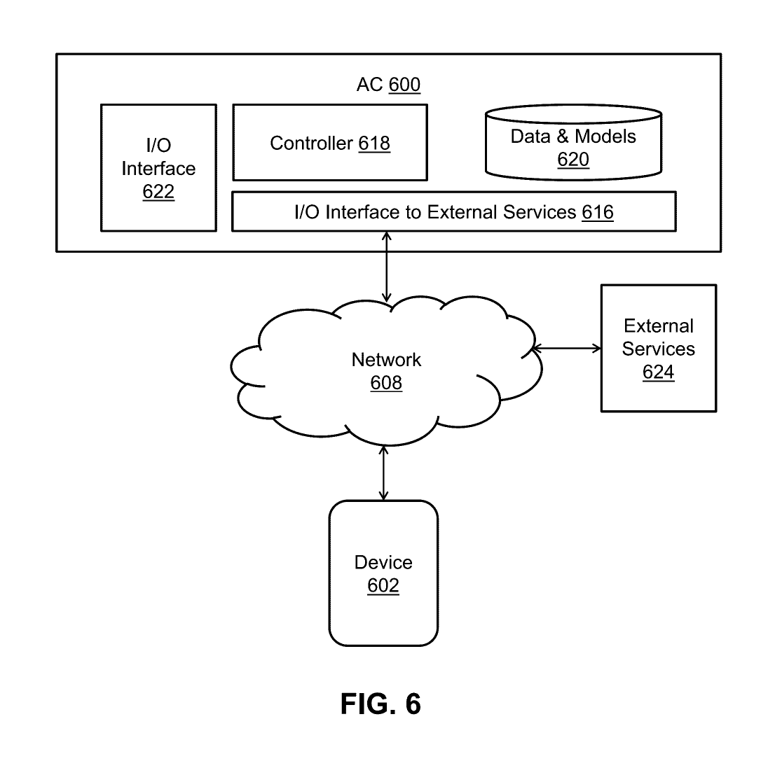

FIG. 6 illustrates an exemplary interaction between an AC 600 and a remote device 602, e.g., a user's smartphone device. As described herein, AC 600 may include various exemplary sensors to carry out various functions. In one example, a variety of sensors are in communication with a controller 618, e.g., an MCU (micro controller unit), local to AC 600. Controller 618, which may include various processing modules, is connected to or is a part of AC 600, and receives and sends data to and from various local sensors and elements, e.g., via an I/O interface 622, or to remote elements, e.g., via I/O interface 616. For example, controller 618 may receive and send signals to various onboard sensors including a weight sensor, location sensor(s) (e.g., GPS sensor), communication sensor(s) (e.g., cellular, Wi-Fi, BLUETOOTH, etc.), and so on. Further, AC 600 via communication sensors may provide a Wi-Fi hotspot for one or more remote devices 602.

Further, controller 618 may send and receive various signals to remote devices, e.g., a user's smartphone or to third party or external services 624 (e.g., cloud services, map services, travel services, and so on). Controller 618 may further store various data and models in storage 420 to store and analyze information as described herein (e.g., to calculate a strength of signal received, battery charge remaining, positional information, and so on).

The following is an exemplary description of possible sensors and exemplary uses with an AC (e.g., AC 100 or AC 600). Exemplary sensors, together with a controller or processor, may also be used by the IC to perform more complex tasks, such as data aggregation, to identify more complex patterns such as type of transportation (aircraft, taxi, bus), and so on.

Inertial Measurements Unit (IMU): In one example, a 9 degree of freedom (DOF) IMU sensor may be included with an AC. Such a sensor makes it possible to measure linear acceleration in three directions, angular speed in three directions, and the magnetic field in three directions. With the use of such information is possible to estimate if the AC is moving, static, was hit, dropped, and so on. Such information may be used to determine the status of the AC, trigger a locking operation of the AC, and so on.

Thermometer: A thermometer sensor can be included to obtain the temperature inside and/or outside the AC. This information can be used to ensure the integrity of delicate goods such as medicines, for example.

Static Pressure (SP): A SP sensor may be included to detect when the AC is inside an aircraft and the status (e.g., flying, landing, taking off, etc.) by tracking the cabin pressure and comparing it with standards patterns.

Contact Sensor: A contact sensor can be used to identify the status of the AC, including access (such as closed, open, compromised, and so on.). Contact sensors can be of several types including magnetic, push button, or mechanical sensors.

Lock Sensor: This sensor can be placed inside the lock mechanism and is used to identify if the lock is set to open or close. In one example, a magnetic or contact sensor is used.

Geolocator or GPS: The AC can include a Geolocator or GPS sensor, which may be used to track the current position of the AC as described herein.

Radio Frequency Identification (RFID): In some examples, the AC may include an RFID tag and/or RFID reader. The AC and remote device may use RFID to connect and remotely unlock the AC based on confirming an identity of a user/remote device.

Signal Strength: With the connection from the AC to the IC most devices have the ability to measure the strength of the signal (e.g., of the BLUETOOTH or other communication signal). With the use of well-known algorithms it is possible to estimate the distance between the AC and the IC based on the strength of the signal.

Tracking Sensor: In some examples, the AC carries a radio frequency trans-receiver (TxRx) which can be the same or different from the one used to link to the IC. The TxRx may include a commercially available module that supports BLUETOOTH, BLE, or the like, and can be used to link the AC to nearby auto-detected ACs. One example use of this function is to create an AC based social network. With the data exchanged between ACs and ICs, it is possible to find nearby friends, a missing suitcase, exchange nearby events, weather information, and so on. Further, a tracking sensor may be tracked also from externally strategically placed ICs (like airports, police stations, parks, etc.). In this fashion it is possible to known where the suitcase is in real time without the need to be in close proximity with the AC.

Unique TAG: In some examples, an AC may have a unique tag that can be acquired in different ways such as optical (photograph), through the IC, TxRx, or a printed label. With an AC unique tag it is possible to match each AC with a user/owner. This feature allows the ability to identify lost ACs and return them to their owner in case stolen and/or lost.

The AC may further include various peripherals. For example, a set of mechanical components can give the AC the ability to perform various physical tasks. The main objective of the peripherals is to translate electrical signals into physical actions such as movements, lights, sound, etc.

Solenoid: In some example, an electromagnetic actuator is used to lock/unlock the device. This component is used to transform electrical signals into linear or rotational displacements and is a standard component for locking or unlocking.

Motor/generator: In some examples, one or more of the wheels of the AC may include one or more motors. For example, a motor can be embedded in the wheels and/or the AC frame. The motor can be used not only to move the AC, but also to assist the user in moving it from one point to another. Also, in some examples, the wheels may allow the user to charge the AC internal battery, e.g., using the motor as a generator to charge the internal battery as the wheels are rotated during use.

Linear actuator: A linear actuator can be used to open the AC access cover/flap after the unlock was performed. Unlike the solenoid this linear actuator provides a much more precise and controlled displacement.

Light Emitting Diode (LED): In some examples, an LED or several multicolor LEDs can be used to give feedback to the user. LEDs can be strategically placed to provide a clear visual indicator of the current status of the AC condition to the user (e.g., locked or unlocked, charged or charging, and so on). The LED may include multiple colors and diverse patterns such as blinking, fading, and so on.

Touch Screen: In some examples, a small screen, such as Liquid Cristal Display (LCD) or LED based, can be used to give the user feedback or status information. This information may be displayed via text and/or graphical images. With the use of a micro-controller it is possible to support multiple languages. Also user input can be taken from the touch capabilities.

Speaker: In some examples, a small speaker may be included with the AC to give audible feedback to a user. For example, audible feedback could be any sound like an alarm, speech, or music.

Microphone: A microphone can further be included to record and receive orders, commands, and the like. For example, with an embedded speech processor component any sound could be translated to AC internal commands.

Feedback for Impaired users: An array of standard components such as solenoids and motors, can be used to give feedback to vision and/or hearing impaired users based on vibration, pokes, and the like.

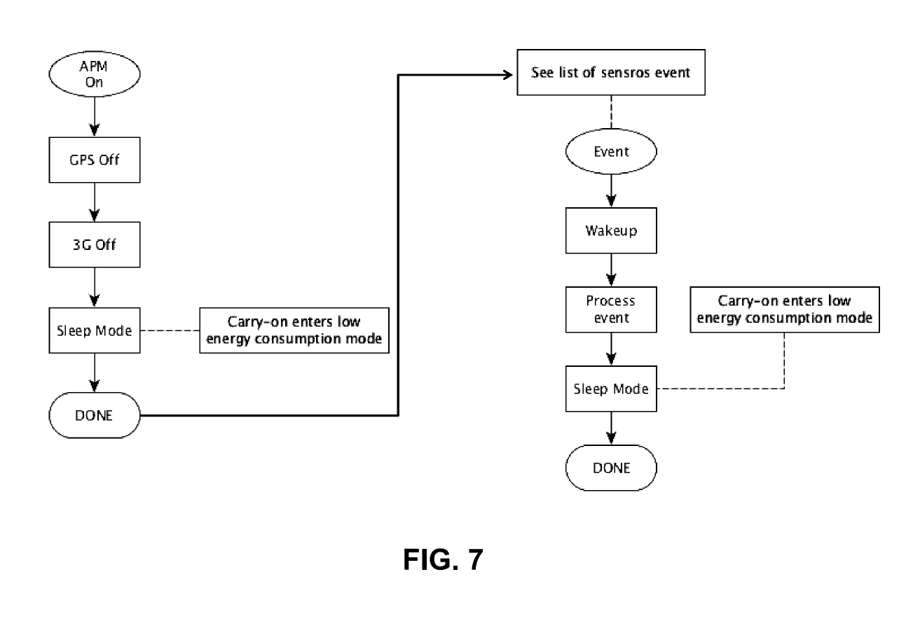

FIGS. 7-9 illustrate exemplary processes the AC and/or IC may carry out. It will be understood that the processes are exemplary and that certain described processes may be carried by the AC alone, the IC alone, or a combination thereof. Further, various processes may be carried out in parallel or in series by the AC and/or IC.

FIG. 7 illustrates an exemplary airplane mode process for an AC. In particular, when airplane mode (“APM”) is activated, e.g., by a user selection on the AC itself or via a remote device through the IC, AC 100 turns off its communication and or location sensors, e.g., GPS, 3G, Wi-Fi, BLUETOOTH, etc., and may power down to a sleep mode to conserve energy. In some examples, a user can still connect to the power supply to power remote devices, e.g., a phone, tablet, or laptop computer, during flight. In one example, only when an event occurs will the system wake up to process the event. After each event is processed the system may go back to sleep (immediately or after a delay), until the airplane mode is disabled (e.g., by the user or other trigger).

Exemplary events may include events related to various sensors or actions. For example, if an accelerometer sensor is included, and a sustained acceleration is detected the system may process this information. Similarly, if a pressure sensor is included, changes in pressure may cause the system to wake and process the information. Additionally, if an external device is connected for charging, e.g., via a USB port, the AC may charge until the external device is fully charged and then return to sleep mode. Additionally, if a flap or door of the AC is opened (via a key, signal, or otherwise), the AC may record the time, date, location, and means of entry, and then return to sleep mode.

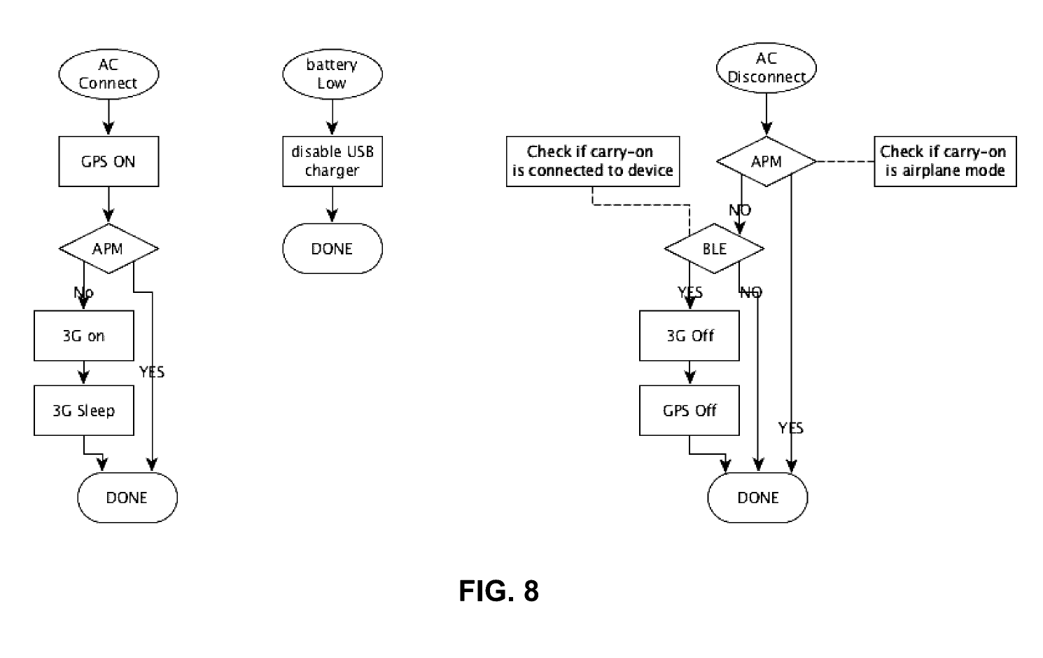

FIG. 8 illustrates various exemplary processes for preserving battery power of an AC. In one example, if an external power supply is connected to the system, and so long as airplane mode is not on, the AC enables the cellular and GPS functions. When the AC is not connected to an external power supply, the AC may determine if the AC is connected to a remote device (e.g., a user phone), and if connected, turn off the location and cellular sensors (e.g., the GPS and 3G). If the system is not connected, the location and cellular systems may operate to provide tracking functions and remote locking as described. Finally, if the battery of the AC falls below a threshold value, the AC may disable the ability to charge external devices to ensure sufficient power is available for other functions, such as tracking and/or remote locking of the AC.

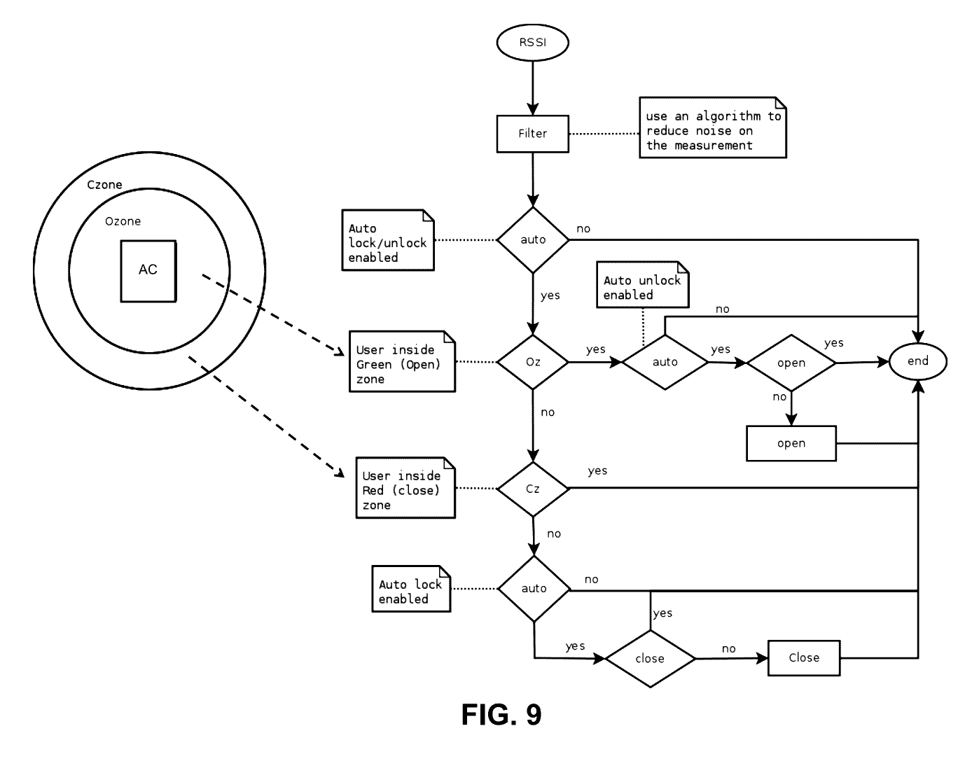

FIG. 9 illustrates an exemplary process for remotely locking an AC based on relative locations or distance of the AC and remote device associated with a user (e.g., a user's smart phone). As illustrated to the left of the flow chart, the exemplary process includes multiple zones (in this example, two) around the AC for which different locking functions may be carried out depending on the relative locations and current state of the AC. For example, in a first zone, indicated as the Open zone (Ozone), the AC can unlock (or remain unlocked). For instance, upon a determination that the user is in close proximity or approaching the AC, the AC may unlock the locking mechanism. Conversely, if the user's position is not known, at a distance greater than a threshold, or moving away from the AC, the AC can act to lock the locking mechanism.

In one example, a Received Signal Strength Indication (RSSI) is determined, e.g., at the AC or the IC (e.g., at the remote device). The signal may be filtered to reduce noise and provide an indication of the relative distance between the AC and the remote device. In other examples, the relative distance between the AC and remote device can be determined from location signals, e.g., GPS signals, and compared accordingly.

In some examples, the AC may include an auto lock mode that can be enabled/disabled, and when disabled no action is taken. If the auto lock mode is enabled, the process determines if the relative distance exceeds one or more threshold values, e.g., whether the user is in the Czone or Ozone. If it is determined the user (or the user's remote device) is in the Ozone the process unlocks the AC.

If the user is outside of the Ozone, e.g., in the Czone (or otherwise not detectable), the AC may lock the AC if not already locked. Further, in some examples, the AC will only automatically lock the AC if an auto lock mode is enabled.

Additionally, the IC may provide a distance alarm to alert the user of various events. For example, as described, the IC is able to track AC sensor data, such as location data, and also the quality of the wireless link to/from the AC. Further, the IC will retain geolocation information regarding the user. With this information, it is possible to estimate not only the distance to the AC but also if there is any obstacle between the user and the AC. This data can be processed to notify the user whenever the AC is left behind by a user. For example, if the IC detects an increase in the distance between the user and the AC, the user can be alerted via their smart phone to double check that the AC was not left behind. The user can further be notified as to the geolocation of the AC.

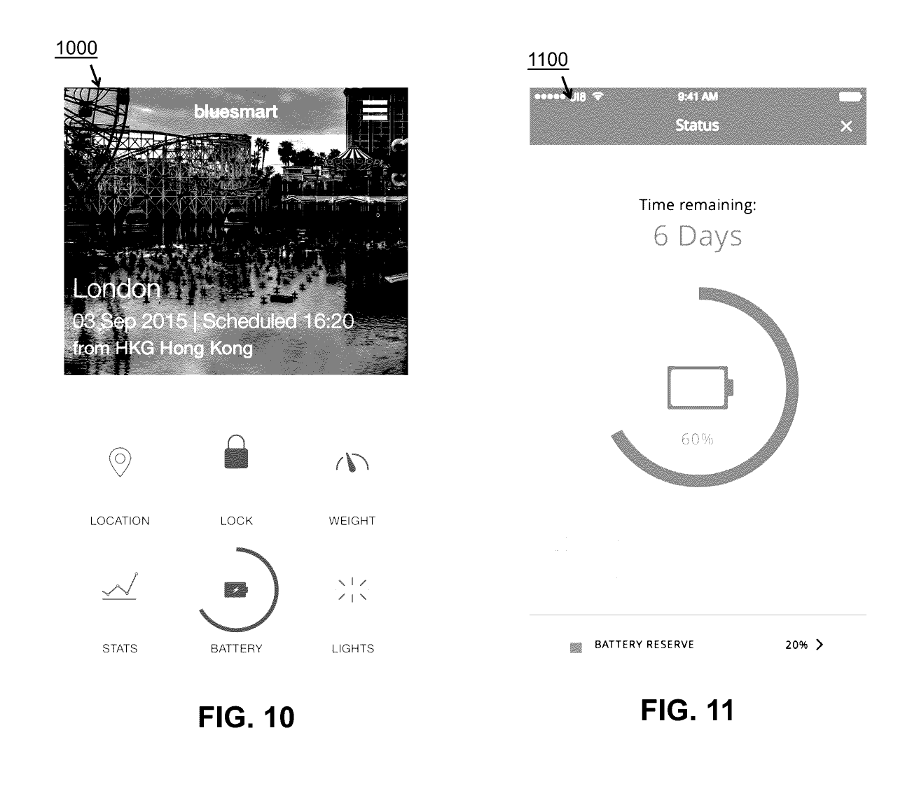

FIGS. 10-16 illustrate various exemplary interfaces associated with an IC. According to one example, the IC includes a processor in communication with a user display (which may be a user interface displayed on a mobile device, e.g., a smart device or smart phone). The IC may receive information captured by the AC sensors, other objects sensors, and its own sensors, to generate data statistics and to perform analysis to improve the overall travel experience of the user. The IC may include an application or a set of applications for a remote device, and may include three separate modules—a user interface (graphic and/or text based), an internal (or remote) database with information regarding the user and the user's objects, and a data processor which will produce higher utility results based on the measurements of devices such as sensors. The IC may be resident in the AC, may be partially or completely in a remote user device, or may be partially or completely in a remote server. Nevertheless, the AC will have the ability to communicate with the IC, such as through a hard wired or wireless connection. All these modules within the AC may interact through a communication bus that will also be used to connect to different objects outside of the AC. The IC will also have the ability to retrieve data from remote hosts through one or more network connections such as WAN, LAN, Internet, or the like.

As an example, user access to the IC could be through a smart phone running the IC (such as an application) that uses GPS capability, or equivalent. The IC can be used to correlate where and when the AC is or was connected. In one example, the AC does not include GPS but the IC does. With GPS or geolocator data, the IC can retrieve the last known position and time of the AC in case the AC is lost.

One aspect provided herein is to monitor the integrity of the AC. With the use of several sensors (e.g., an internal measurement unit, contact sensors, magnetic sensors, push buttons, etc.) the AC is able to identify and notify the IC if the AC has been or is opened, violated, the lock forced, kicked, and the like. One or more sensors associated with the lock and pressure sensors, among other sensors, provide data regarding the aforementioned conditions. This information can then be correlated to other information stored and available in the IC to keep the user informed through the IC as to when the AC is properly locked, notify the user when the AC is open, notify the when the AC is closed, and store and/or provide the user a list of times, locations, and reasons for opening and/or closing the AC, which may be used to identify who open the AC (for instance to distinguish TSA inspection, possible robbery, or other possible sources).

The IC further serves as a data repository and as an element for data retrieval, both from the AC itself and from external sources. The IC can be used to track data and provide analysis. Users can enter data about their trip and the IC can analyze the collection of data to provide advice to users regarding the user's destination and associated needs. Further, the IC can learn user habits and customs, provide guidance to the user about their habits and customs, and suggest ways for improvement, thereby directing the user toward adaptive learning so as to improve certain characteristics (such as avoiding over packing, avoiding overcharging of devices, etc.). Furthermore the data from different users may be “merged” to generate global statistics that can be used to give a user better understanding of the travel and destination.

FIG. 10 illustrates an exemplary screen shot of a dashboard user interface 1000 of an IC for communicating with and controlling the AC. A dashboard may allow a user to graphically control and view their behavior and use of the AC. For example, the dashboard may provide suggestions about use, status, and condition of the AC sensors and actuators, and also to configure the AC actions to achieve desired behaviors of the AC (e.g., setting auto lock modes, tracking, visual indicators, and the like).

In this example, user interface 1000 includes an image associated with a trip or travel destination and selectable icons for obtaining information and/or controlling the AC. For instance, user interface 1000 may include icons for determining the location of the AC, detecting the locking state or locking/unlocking the AC, detecting the weight of or weighing the AC, detecting the power or charge of the internal batter of the AC, locating or lighting the AC, and/or viewing various other statistics related to the AC. It will be recognized that fewer or additional icons and controls may be used and are contemplated.

FIG. 11 illustrates an exemplary user interface 1100 for displaying indications of the AC's internal power supply. Additionally, interface 1100 may include an indication or status of the charging of external devices, and if available, the identity and/or current charge of the external devices.

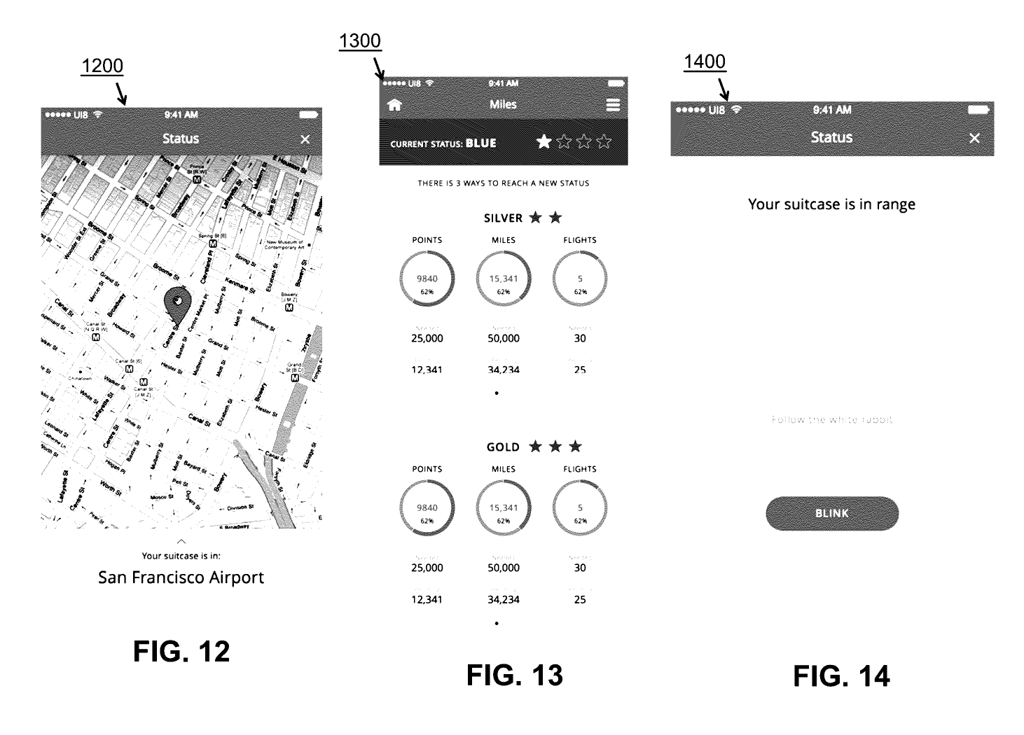

FIG. 12 illustrates an exemplary user interface 1200 for displaying the location status of the AC. In this example, the interface displays a map and textual description of the location of the AC. Additionally, the user interface may provide directions from your current location to the AC, e.g., driving directions if appropriate, or walking directions to a baggage carousel in the airport as appropriate. Further, geographical locations can be stored and used to geo-locate the last place where an AC was detected (e.g., in cases where an AC is lost or stolen), show historical movement of the AC, and so on.

FIG. 13 illustrates an exemplar user interface 1300 for displaying statistics relating to a user's travel, which may include mileage or reward plans. For example, user interface 1300 may display miles traveled, trips, points, destinations, and so on. In this manner, a user can obtain information about the use of the AC, the miles traveled, how many times devices were charged, and other information such as but not limited to how many times opened, closed, locked, weights, moving, stopped, etc.

Various services leveraging the information gathered by the AC and/or IC are contemplated. For example, it is possible to track and provide miles and/or travel based warranties, closest service shop auto-find, travel based social network with features such as but not limited to most miles traveled ranking, most used airliners, and so on.

FIG. 14 illustrates an exemplary user interface 1400 for locating your suitcase, particularly in close range such as at a baggage claim. In one example, a short distance messaging connection, such as BLUETOOTH can be used for this process. In particular, the strength of the signal can be correlated to a distance and thereby provide general direction for the user as the user walks to or away from the luggage. Additionally, the AC can blink or light up as the user approaches, providing a visual indication of the location.

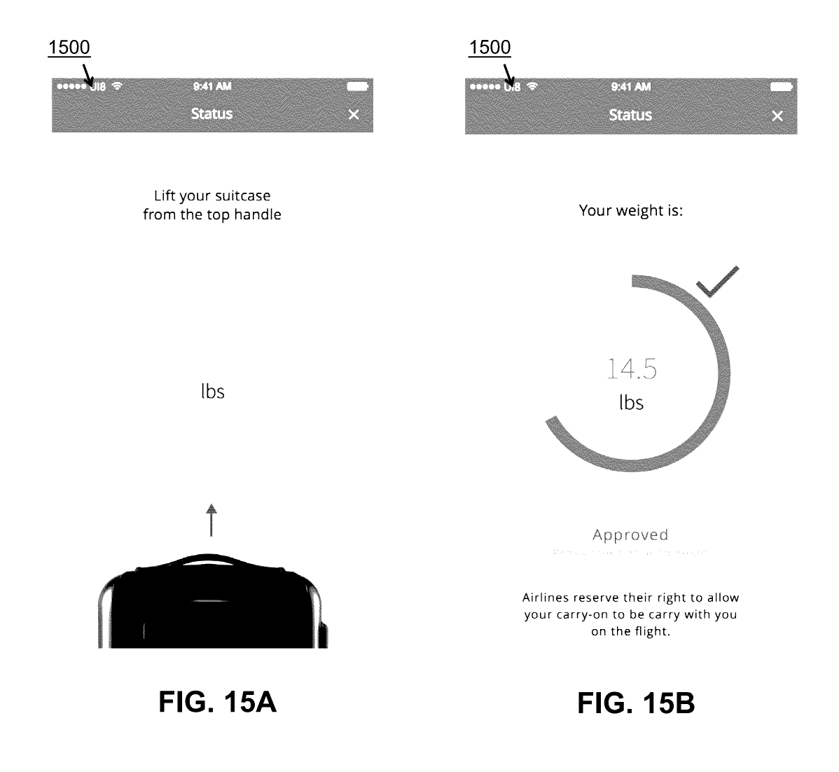

FIGS. 15A and 15B illustrate an exemplary user interface for determining the weight of the AC. For example, when the icon is selected to invoke user interface 1500, the user can be prompted to lift the AC by the handle. When lifted, and the AC detects the weight, the weight can be communicated to the IC and displayed as shown in FIG. 15B. User interface 1500 can display the weight and/or whether this weight conforms to approved limits, e.g., of an airline (if known to the IC), as shown in FIG. 15B.

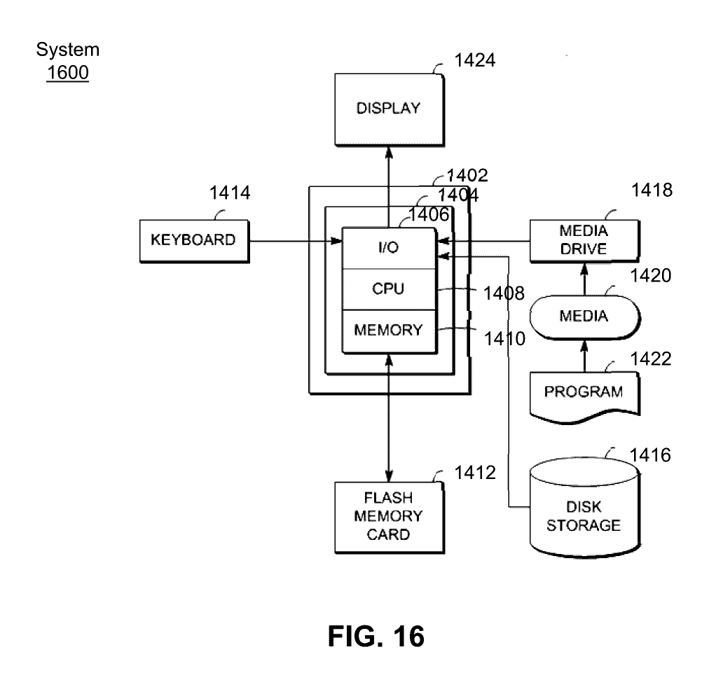

FIG. 16 depicts an exemplary computing system 1600 configured to perform any one of the above-described processes, including the various location detection, auto-locking features, and generation of user interfaces. In this context, computing system 1600 may include, for example, a processor, memory, storage, and input/output devices (e.g., monitor, wireless connections, keyboard/touchscreens, Internet connection, and the like.). However, computing system 1600 may include circuitry or other specialized hardware for carrying out some or all aspects of the processes. In some operational settings, computing system 1600 may be configured as a system that includes one or more units, each of which is configured to carry out some aspects of the processes either in software, hardware, or some combination thereof.

FIG. 16 depicts computing system 1600 with a number of components that may be used to perform the above-described processes. The main system 1402 includes a motherboard 1404 having an input/output (“I/O”) section 1406, one or more central processing units (“CPU”) 1408, and a memory section 1410, which may have a flash memory card 1412 related to it. The I/O section 1406 is connected to a display 1424, a keyboard 1414, a disk storage unit 1416, and a media drive unit 1418. The media drive unit 1418 can read/write a computer-readable medium 1420, which can contain programs 1422 and/or data.

At least some values based on the results of the above-described processes can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++, Java) or some specialized application-specific language.

Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt a particular situation, material, composition of matter, process, process act(s) or step(s) to the objective(s), spirit or scope of the various embodiments. Further, as will be appreciated by those with skill in the art, each of the individual variations described and illustrated herein has discrete components and features that may be readily separated from or combined with the features of any of the other several embodiments without departing from the scope or spirit of the various embodiments. All such modifications are intended to be within the scope of claims associated with this disclosure.

1-27. (canceled)

28. A wheel for an active container, the wheel comprising:
a hollow inner hub;
a hollow outer wheel; and
a bearing member disposed between the hollow inner hub and the hollow outer wheel, wherein the hollow outer wheel is operable to rotate relative to the hollow inner hub, and the hollow inner hub is attached to a mounting member for mounting the wheel.

29. The wheel of claim 28, further comprising a motor coupled to the wheel and operable to rotate the outer wheel relative to the inner hub.

30. The wheel of claim 28, further comprising a generator coupled to the wheel and operable to generate current in response to the outer wheel being rotated relative to the inner hub.

31. The wheel of claim 28, wherein the mounting member comprises a vertically oriented rod.

32. The wheel of claim 28, further comprising a motor coupled to the wheel and operable to steer the wheel.

33. The wheel of claim 28, wherein the bearing member comprises plastic.

34. The wheel of claim 28, wherein the bearing member comprises a ball bearing assembly.

35. The wheel of claim 28, further comprising a mounting frame for supporting the mounting member and hollow inner hub.

36. A wheel for an active container, the wheel comprising:
an inner hub;
a hollow outer wheel;
a bearing member disposed between the inner hub and the hollow outer wheel, wherein the hollow outer wheel is operable to rotate relative to the hollow inner hub, and the inner hub is attached to a mounting member for mounting the wheel; and
a motor coupled to the wheel and operable to rotate the outer wheel relative to the inner hub.

37. The wheel of claim 36, further comprising a generator operable to generate current in response to the outer wheel being rotated relative to the inner hub.

38. The wheel of claim 36, wherein the bearing member comprises plastic.

39. The wheel of claim 36, wherein the bearing member comprises a ball bearing assembly.

40. The wheel of claim 36, further comprising a mounting frame for supporting the mounting member and inner hub.
